(19) United States
(12) Patent Application Publication
(10) Pub. No.: US 2005/0086274 A1
(43) Pub. Date: Apr. 21, 2005

(54) Sample-and-hold method

(75) Inventor: Ryutaro Mori, Saitama-shi (JP)

Correspondence Address: MORRISON & FOERSTER LLP, 1650 TYSONS BOULEVARD, SUITE 300, MCLEAN, VA, 22102, US

(73) Assignee: ASSETCORE TECHNOLOGY CO., LTD., Yokohama-shi (JP)

(21) Appl. No.: 10/752,093

(22) Filed: Jan. 7, 2004

(30) Foreign Application Priority Data
Aug. 26, 2003 (JP) 2003-301728
Nov. 6, 2003 (JP) 2003-377508

(51) Int. Cl. G06F 7/00

(52) U.S. Cl. 708/200

(57) ABSTRACT

To provide a sample-and-hold method which can limit the storage capacity of storage media needed to a bare minimum and can independently manage a series of data contained in a predetermined interval before the arrival time of a trigger signal and a series of data contained in a predetermined interval after the arrival time of the trigger signal by separating them clearly. The present invention comprises a primary storage medium; an area definition data storage means for storing area definition data that defines a first storage area which corresponds to the interval before the arrival time and a second storage area which corresponds to the interval after the arrival time in the primary storage medium; a first write control means for continuing to write a series of incoming data into the first storage area defined by the area definition data, using wrap around addressing until the trigger signal arrives; and a second write control means for writing a series of data arriving after the arrival of the trigger signal into the second storage area defined by the area definition data instead of ceasing to write data into the first storage area when the trigger signal arrives.

### TECHNICAL FIELD

The present invention relates to a sample-and-hold method suitable for various data analyses. More particularly, it relates to a sample-and-hold method for reliably sampling and holding only series of data which arrive during predetermined intervals before and after the arrival time of a predetermined trigger signal, out of a series of data which arrives successively.

### BACKGROUND OF THE INVENTION

It will be convenient for various data analyses if it is possible to sample and hold only series of data which arrive during predetermined intervals before and after the arrival time of a predetermined trigger signal, out of a series of data which arrives successively.

For example, in monitoring visitors using a security camera installed at the door, a method is known which involves detecting a visitor's arrival using a sensor installed separately or based on changes in video images themselves or the like, and this detection is used as a trigger for storing video data for a fixed period after the detection (as described in the Japanese Patent Laid-Open Publication No. H04-32390). In so doing, in addition to the video data for the fixed period after the detection, if video data for a fixed period before the detection can also be stored, it will be possible to observe the visitor in greater detail by reproducing video images based on both sets of the stored data.

Also, in the field of monitoring systems, a method is known which involves monitoring the state of an object based on measured data from two or more measuring instruments and a match between a feature value representing the measured data and a feature value representing occurrence of an expected event act as a trigger for storing the measured data for a fixed period after the trigger. In so doing, in addition to the measured data for the fixed period after the trigger, if measured data for a fixed period before the trigger can also be stored, both sets of the measured data stored will be useful in verifying the accuracy of detecting the occurrence of the event as well as in predicting the occurrence of the event.

Furthermore, when monitoring the state of a car based on measured data from two or more measuring instruments, if it is possible to store not only measured data for a fixed period after an accident, but also measured data for a fixed period before an accident, using a match between a feature value representing the measured data and a feature value representing occurrence of the accident as a trigger, both sets of the measured data stored will be useful in investigating the cause of the accident.

An object of the present invention is to provide a sample-and-hold method and apparatus which can reliably sample and hold only series of data which arrive during predetermined intervals before and after the arrival time of a predetermined trigger signal, out of a series of data which arrives successively.

Another object of the present invention is to provide a sample-and-hold method and apparatus which can limit the storage capacity of storage media needed to achieve the above object to a bare minimum and can independently manage a series of data contained in a predetermined interval before the arrival time of a trigger signal and a series of data contained in a predetermined interval after the arrival time of the trigger signal by separating them clearly.

Still another object of the present invention is to provide a versatile semiconductor integrated circuit suitable for reliably sampling and holding only series of data which arrive during predetermined intervals before and after the arrival time of a predetermined trigger signal, out of a series of data which arrives successively.

Other objects of the present invention will become readily apparent to those skilled in the art from the following description.

### BRIEF SUMMARY OF THE INVENTION

The present invention provides a data string sample-and-hold method for sampling and holding only series of data which arrive during predetermined intervals before and after the arrival time of a predetermined trigger signal, out of a series of data which arrives successively. This method comprises a first step for preparing a primary storage medium in which a first storage area corresponding to the interval before the arrival time of the trigger signal and a second storage area corresponding to the interval after the arrival time of the trigger signal have been defined; a second step for continuing to write a series of incoming data into the first storage area using wrap-around addressing until the trigger signal arrives; and a third step for writing a series of data arriving after the arrival of the trigger signal into the second storage area instead of ceasing to write data into the first storage area when the trigger signal arrives.

With this configuration, the series of data arriving before the arrival of the trigger signal is stored in the first storage area of the primary storage medium and the series of data arriving after the arrival of the trigger signal is stored in the second storage area of the primary storage medium. Thus, this method can limit the required storage capacity of storage media to a bare minimum and can independently manage the series of data contained in a predetermined interval before the arrival time of a trigger signal and the series of data contained in a predetermined interval after the arrival time of the trigger signal by separating them clearly.

If the primary storage medium is a nonvolatile storage medium such as an optical memory suitable for high-speed storage or a volatile storage medium such as a DRAM equipped with back-up power, even in incidences wherein power is shut down upon the arrival of the trigger signal, the series of data which arrive during the predetermined intervals before and after the arrival time of the trigger signal can be sampled and held in a reliable manner.

The sample-and-hold method of the present invention may further comprise a fourth step of transferring the data written into the first and second storage areas of the primary storage medium to a secondary storage medium after the completion of the third step.

With this configuration, the series of data arriving before the arrival of the trigger signal and stored in the first storage area of the primary storage medium as well as the series of data arriving after the arrival of the trigger signal and stored in the second storage area of the primary storage medium are transferred to the secondary storage medium. Thus, this method can limit the required storage capacity of storage media to a bare minimum and can independently and safely manage the series of data contained in a predetermined interval before the arrival time of a trigger signal and the series of data contained in a predetermined interval after the arrival time of the trigger signal by separating them clearly. Moreover, since sampled and held data strings are eventually stored in the secondary storage medium, the waiting operation for the next sample-and-hold operation is not hindered.

Here, if the primary storage medium is a volatile storage medium such as a DRAM suitable for high-speed storage and secondary storage medium is a nonvolatile storage medium such as a flash memory or hard disk, it is possible to ensure high memory speed and safety of stored data.

In the two sample-and-hold methods described above, preferably the storage capacity of the first storage area is an integral multiple of the storage capacity of the second storage area (more preferably the former is twice the latter) This will make it easy to collate the data stored in the first storage area and data stored in the second storage area in units of data strings (frames) when image data or voice data divided into frames are handled.

The present invention provides a sample-and-hold apparatus for sampling and holding only series of data which arrive during predetermined intervals before and after the arrival time of a predetermined trigger signal, out of a series of data which arrives successively. This apparatus comprises a primary storage medium; an area definition data storage means for storing area definition data that defines a first storage area which corresponds to the interval before the arrival time of the trigger signal and a second storage area which corresponds to the interval after the arrival time of the trigger signal in the primary storage medium; a first write control means for continuing to write a series of incoming data into the first storage area defined by the area definition data, using wrap-around addressing until the trigger signal arrives; and a second write control means for writing a series of data arriving after the arrival of the trigger signal into the second storage area defined by the area definition data instead of ceasing to write data into the first storage area when the trigger signal arrives.

With this configuration, the series of data arriving before the arrival of the trigger signal is stored in the first storage area of the primary storage medium and the series of data arriving after the arrival of the trigger signal is stored in the second storage area of the primary storage medium. Thus, this method can limit the required storage capacity of storage media to a bare minimum and can independently manage the series of data contained in a predetermined interval before the arrival time of a trigger signal and the series of data contained in a predetermined interval after the arrival time of the trigger signal by separating them clearly.

If the primary storage medium is a nonvolatile storage medium such as an optical memory suitable for high-speed storage or a volatile storage medium such as a DRAM equipped with back-up power, even in incidences wherein power is shut down upon the arrival of the trigger signal, the series of data which arrive during the predetermined intervals before and after the arrival time of the trigger signal can be sampled and held in a reliable manner.

The sample-and-hold apparatus of the present invention may further comprise a secondary storage medium; and a data transfer control means for transferring the data written into the first and second storage areas of the primary storage medium to a secondary storage medium.

With this configuration, the series of data arriving before the arrival of the trigger signal and stored in the first storage area of the primary storage medium as well as the series of data arriving after the arrival of the trigger signal and stored in the second storage area of the primary storage medium are transferred to the secondary storage medium. Thus, this method can limit the required storage capacity of storage media to a bare minimum and can independently and safely manage the series of data contained in a predetermined interval before the arrival time of a trigger signal and the series of data contained in a predetermined interval after the arrival time of the trigger signal by separating them clearly. Moreover, since sampled and held data strings are eventually stored in the secondary storage medium, the waiting operation for the next sample-and-hold operation is not hindered.

Here, if the primary storage medium is a volatile storage medium such as a DRAM suitable for high-speed storage and secondary storage medium is a nonvolatile storage medium such as a flash memory or hard disk, it is possible to ensure high memory speed and safety of stored data.

The sample-and-hold apparatus of the present invention may comprise area definition data generating means for internally generating area definition data based on input data from outside. As described above, the “area definition data” is data that defines the first storage area corresponding to the interval before the arrival time of the trigger signal and the second storage area corresponding to the interval after the arrival time of the trigger signal in the primary storage medium. The area definition data can be given as the starting address and ending address of each of the areas, maximum byte count from the starting address, or the like. This configuration makes it possible to configure the area definition data properly by providing input data from outside.

Here, the input data from outside may contain both data indicating the capacity of the first storage area and data indicating the capacity of the second storage area, and the area definition data generating means may generate area definition data based on the two sets of data. This configuration makes it possible to set the first storage area and second storage area individually to any desired capacity by providing input data from outside.

Alternatively, the input data from outside may contain data indicating the capacity of the first storage area, but not data indicating the capacity of the second storage area, and the area definition data generating means may generate area definition data based only on the data indicating the capacity of the first storage area. This configuration makes it possible to set the capacity of the first storage area and capacity of the second storage area properly by simply supplying input data which represents only the capacity of the first storage area, provided that an appropriate correlation between the capacity of the first storage area and capacity of the second storage area is defined in advance.

In the two sample-and-hold apparatus described above, preferably the storage capacity of the first storage area is an integral multiple of the storage capacity of the second storage area (more preferably the former is twice the latter). This will make it easy to collate the data stored in the first storage area and data stored in the second storage area in units of data strings when image data or voice data divided into frames are handled if the capacity of the second storage area is related to the size of, for example, the frame in advance.

Viewed from another angle, the present invention provides a highly versatile semiconductor integrated circuit suitable for implementing the above methods and apparatus. The semiconductor integrated circuit comprises a first port which a series of data to be sampled are inputted; a second port which a predetermined trigger signals are inputted; a third port connected to a predetermined storage medium; a fourth port which outputs series of sampled and held data; an area definition data storage means for storing area definition data which defines a first storage area and a second storage area in the storage medium connected to the third port; a first write control means for continuing to write a series of data inputted through the first port into the first storage area of the storage medium connected to the third port, using wrap around addressing until a trigger signal is inputted through the second port; a second write control means for writing a series of data arriving after the arrival of the trigger signal into the second storage area of the storage medium instead of ceasing to write data into the first storage area of the storage medium when the trigger signal is inputted through the second port; and data read control means for performing control over transmission of data stored in the first storage area and the second storage area of the storage medium connected with the third port to the fourth port.

With this configuration, simply by inputting a series of data to be sampled to the first port and inputting a predetermined trigger signal to the second port with the primary storage medium connected to the third port, the first and second storage areas can be defined properly in the primary storage medium. Furthermore, upon the arrival of the trigger signal, the data string in a fixed interval immediately before the arrival of the trigger signal is stored in the first storage area of the primary storage medium and the data string in a fixed interval immediately after the arrival of the trigger signal is stored in the second storage area of the primary storage medium. Subsequently, the data strings stored in the primary storage medium are read to the outside through the fourth port.

If the primary storage medium is a nonvolatile storage medium such as an optical memory suitable for high-speed storage or a volatile storage medium such as a DRAM equipped with back-up power, even in incidences wherein power is shut down (e.g., due to a car crash or the like when the semiconductor integrated circuit is used as an in-car data logger) upon the arrival of the trigger signal, the series of data which arrive during the predetermined intervals before and after the arrival time of the trigger signal can be sampled and held in a reliable manner.

The first to fourth ports described above are not necessarily meant to be independent of each other. A single port may implement the functions of two or more ports. For example, A single physical port may combine the function of the first port to input series of data to be sampled and the function of the second port to input predetermined trigger signals.

The semiconductor integrated circuit of the present invention may comprise a power controller for supplying power not only in the semiconductor integrated circuit, but also to the storage medium connected externally, and to an oscillator connected externally and supplies an operation clock to the semiconductor integrated circuit. Since this configuration eliminates the need for a power supply to the storage medium and to the clock oscillator, it simplifies design accordingly. Here, if the semiconductor integrated circuit is equipped with an external terminal for connecting a super capacitor which maintains electric power supplied from the power controller for a predetermined time during a power failure, then by connecting a super capacitor to the circuit, it is possible to keep the operation clock oscillator and storage medium functioning properly even in case of a power failure upon arrival of a trigger signal, and thereby ensuring the reliability of sample-and-hold operations.

The semiconductor integrated circuit of the present invention may comprise a fifth port which control data are inputted; and an area definition data generating means for internally generating area definition data based on the control data inputted through the fifth port. This configuration makes it possible to set up appropriate storage areas according to various sampling data by inputting appropriate control data to the fifth port from outside.

Here, the control data from outside may contain both data indicating the capacity of the first storage area and data indicating the capacity of the second storage area, and the area definition data generating means may generate area definition data based on the two sets of data. This configuration makes it possible to set the first storage area and second storage area individually to any desired capacity by providing input data from outside.

Alternatively, the control data from outside may contain data indicating the capacity of the first storage area, but not data indicating the capacity of the second storage area, and the area definition data generating means may generate area definition data based only on the data indicating the capacity of the first storage area. This configuration makes it possible to set the capacity of the first storage area and capacity of the second storage area properly by simply supplying control data which represents only the capacity of the first storage area, provided that an appropriate correlation between the capacity of the first storage area and capacity of the second storage area is defined in advance.

Viewed from another angle, the present invention provides a semiconductor integrated circuit comprising: a first port which series of data to be sampled are inputted; a second port which predetermined trigger signals are inputted; a third port connected to a predetermined primary storage medium; a fourth port connected to a predetermined secondary storage medium; a fifth port which reads sampled and held data; an area definition data storage means for storing area definition data which defines a first storage area and a second storage area in the primary storage medium connected to the third port; a first write control means for continuing to write a series of data inputted through the first port into the first storage area of the primary storage medium connected to the third port, using wrap around addressing until a trigger signal is input through the second port; a second write control means for writing a series of data arriving after the arrival of the trigger signal into the second storage area of the primary storage medium instead of ceasing to write data into the first storage area of the primary storage medium when the trigger signal is inputted through the second port; a data transfer control means for transferring the data written into the first and second storage areas of the primary storage medium connected with the third port to a secondary storage medium connected with the fourth port; and a data read control means for performing control over transmission of data stored in the secondary storage medium connected with the fourth port to the fifth port.

With this configuration, simply by inputting a series of data to be sampled to the first port and inputting a predetermined trigger signal to the second port with the primary storage medium connected to the third port and the secondary storage medium connected to the fourth port, the first and second storage areas can be defined properly in the primary storage medium. Furthermore, upon the arrival of the trigger signal, the data string in a fixed interval immediately before the arrival of the trigger signal is stored in the first storage area of the primary storage medium and the data string in a fixed interval immediately after the arrival of the trigger signal is stored in the second storage area of the primary storage medium, and then the data strings are transferred to the secondary storage medium. Subsequently, the data strings stored in the secondary storage medium are read to the outside through the fourth port.

Here, if the primary storage medium is a nonvolatile storage medium such as a DRAM suitable for high-speed storage and secondary storage medium is a nonvolatile storage medium such as a flash memory or hard disk, it is possible to ensure high memory speed and safety of stored data.

The semiconductor integrated circuit of the present invention may comprise a power controller for supplying power not only in the semiconductor integrated circuit, but also to the primary and secondary storage media connected externally, and to an oscillator connected externally and supplies an operation clock to the semiconductor integrated circuit. Since this configuration eliminates the need for a power supply on the primary and secondary storage media and on the clock oscillator, it simplifies design accordingly. Here, if the semiconductor integrated circuit is equipped with an external terminal for connecting a super capacitor which maintains electric power supplied from the power controller for a predetermined time during a power failure, then by connecting a super capacitor to the circuit, it is possible to keep the operation clock oscillator and primary and secondary storage media functioning properly even in case of a power failure upon arrival of a trigger signal, and thereby ensure the reliability of sample-and-hold operations. For example, even in incidences wherein power is shut down (e.g., due to a car crash or the like when the semiconductor integrated circuit is used as an in-car data logger) upon the arrival of the trigger signal, the series of data which arrive during predetermined intervals before and after the arrival time of the trigger signal can be sampled and held reliably in the primary storage medium, and then transferred and saved in the secondary storage medium.

The semiconductor integrated circuit of the present invention may comprise a sixth port which control data are inputted; and an area definition data generating means for internally generating area definition data based on the control data inputted through the sixth port. This configuration makes it possible to set up appropriate storage areas according to various sampling data by inputting appropriate control data to the sixth port from outside.

Here, the control data from outside may contain both data indicating the capacity of the first storage area and data indicating the capacity of the second storage area, and the area definition data generating means may generate area definition data based on the two sets of data. This configuration makes it possible to set the first storage area and second storage area individually to any desired capacity by providing input data from outside.

Alternatively, the control data from outside may contain data indicating the capacity of the first storage area, but not data indicating the capacity of the second storage area, and the area definition data generating means may generate area definition data based only on the data indicating the capacity of the first storage area. This configuration makes it possible to set the capacity of the first storage area and capacity of the second storage area properly by simply supplying control data which represents only the capacity of the first storage area, provided that an appropriate correlation between the capacity of the first storage area and capacity of the second storage area is defined in advance.

In the two sample-and-hold apparatus described above, preferably the storage capacity of the first storage area is an integral multiple of the storage capacity of the second storage area (more preferably the former is twice the latter). This will make it easy to collate the data stored in the first storage area and data stored in the second storage area in units of data strings when image data or voice data divided into frames are handled if the capacity of the second storage area is related to the size of the frame in advance.

The sample-and-hold method and apparatus according to the present invention can reliably sample and hold only series of data which arrive during predetermined intervals before and after the arrival time of a predetermined trigger signal, out of a series of data which arrives successively.

The sample-and-hold method and apparatus according to the present invention can limit the required storage capacity of storage media to a bare minimum and can independently manage a series of data contained in a predetermined interval before the arrival time of a trigger signal and a series of data contained in a predetermined interval after the arrival time of the trigger signal by separating them clearly.

Furthermore, with the semiconductor integrated circuit for sampling and holding according to the present invention, simply by inputting a series of data to be sampled to the first port and inputting a predetermined trigger signal to the second port with the primary storage medium and/or the secondary storage medium each connected to an appropriate port, the first and second storage areas can be defined properly in the primary storage medium. Furthermore, upon the arrival of the trigger signal, the data string in a fixed interval immediately before the arrival of the trigger signal is stored in the first storage area of the primary storage medium and the data string in a fixed interval immediately after the arrival of the trigger signal is stored in the second storage area of the primary storage medium. Also, the data strings are transferred to the secondary storage medium as required. Subsequently, the data strings stored in the primary storage medium or secondary storage medium can be read to the outside through a predetermined port.

### BRIEF DESCRIPTION OF THE DRAWINGS

FIG. 1 is a block diagram of a sample-and-hold apparatus according to the present invention;

FIG. 2 is a general flowchart showing operation of the control CPU;

FIG. 3 is a detailed flowchart of a settings process;

FIG. 4 is an explanatory diagram illustrating a memory map of a primary storage medium and format of stored data;

FIG. 5is a general flowchart showing operation of a memory controller;

FIG. 6 is a detailed flowchart of a sample-and-hold process;

FIG. 7 is an explanatory diagram illustrating operation of the present invention;

FIG. 8 is a block diagram of a data recorder to which a sample-and-hold IC according to the present invention is applied; and

FIG. 9 is a block diagram of a monitoring device to which the sample-and-hold IC according to the present invention is applied.

### DETAILED DESCRIPTION OF THE PREFERRED EMBODIMENTS

A preferred embodiment of the present invention will be described in detail below with reference to the drawings. It should be noted that the scope of the present invention is not limited by the embodiment described below and is defined only by the appended claims.

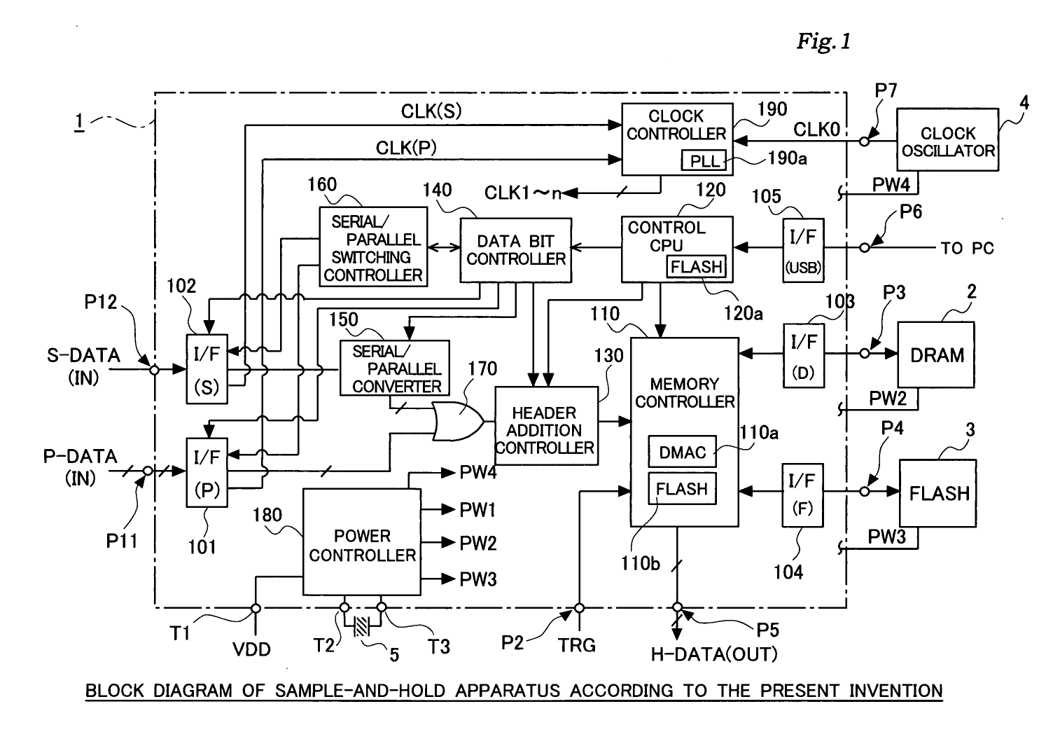

A block diagram of a sample-and-hold apparatus according to the present invention is shown in FIG. 1. As shown in the figure, the sample-and-hold apparatus comprise mainly of a semiconductor integrated circuit 1 specifically designed for sampling and holding, DRAM 2 which functions as a primary storage medium, flash memory (FLASH) 3 which functions as a secondary storage medium, and clock oscillator 4 which supplies an operation clock to the semiconductor integrated circuit 1.

The semiconductor integrated circuit 1 is equipped with a plurality of external ports. A port P11 receives parallel inputs of series of data to be sampled. In FIG. 1, P-DATA (IN) indicates parallel input data. A port P12 receives serial inputs of series of data to be sampled. In FIG. 1, S-DATA (IN) indicates serial input data. In this way, the semiconductor integrated circuit 1 can be inputted with series of data to be sampled, both as parallel data and as serial data.

A port P2 is inputted with a predetermined trigger signal. In FIG. 1, TRG indicates the trigger signal. As described in detail later, the semiconductor integrated circuit 1 can sample and hold only the data strings which arrive during predetermined intervals before and after the arrival of the trigger signal TRG, out of the series of data to be sampled inputted through the port P11 or P12.

A port P3 is used to connect the DRAM 2, a primary storage medium. As described in detail later, as a result of a sample-and-hold process, the data strings which arrive during predetermined intervals before and after the arrival of the trigger signal TRG are stored first in the DRAM 2 which is a primary storage medium. The DRAM 2 draws power PW2 from the semiconductor integrated circuit 1.

A port P4 is used to connect the flash memory (FLASH) 3, a secondary storage medium. As described in detail later, the sample-and-hold data stored in the DRAM 2 is transferred and saved in the flash memory (FLASH) 3 upon completion of the sample-and-hold process. The flash memory (FLASH) 3 also draws power PW3 from the semiconductor integrated circuit 1.

A port P5 is used to read held data to the outside. In FIG. 1, H-DATA (OUT) indicates the sample-and-hold data read out. According to this embodiment, the sample-and-hold data H-DATA (OUT) is read out of the flash memory (FLASH) 3 and is outputted to the outside via the port P5.

A port P6 is used to send control data and the like from a personal computer (PC) to the semiconductor integrated circuit 1. According to this embodiment, USB is used for communications with the personal computer (PC), but the communication method is not limited to the use of USB.

A port P7 is used to supply the operation clock CLK0 generated by the clock oscillator 4 to the semiconductor integrated circuit 1. That is, the semiconductor integrated circuit 1 comprise of a clock-synchronized wired logic circuits as described in detail later, and the operation clock CLK0 needed for the operation of the clock-synchronized wired logic circuit is supplied from the clock oscillator 4 via the port P7. The clock oscillator 4 also draws power PW4 from the semiconductor integrated circuit 1.

Next, major external terminals will be described. An external terminal T1 is used to supply power VDD to the semiconductor integrated circuit 1. The power VDD supplied through the external terminal T1 is supplied to a power controller 180 in the semiconductor integrated circuit 1. The power controller 180 stabilizes and regulates the supplied power VDD, and thereby outputs power in four systems, PW1 to PW4, of which the power PW1 is supplied to various circuits in the semiconductor integrated circuit 1. As described above, the power PW2 is supplied to the DRAM 2 connected to the port P3, the power PW3 is supplied to the flash memory (FLASH) 3 connected to the port P4, and the power PW4 is supplied to the clock oscillator 4 connected to the port P7. External terminals T2 and T3 are used to connect a super capacitor 5 externally. Electric charges stored in the super capacitor 5 are used to maintain the power in four systems PW1 to PW4 outputted from the power controller 180 for a predetermined period of time during a power failure. In this example, the capacity of the super capacitor 5 has been determined such that even in incidences wherein the power VDD is interrupted immediately after arrival of the trigger signal TRG, the power PW1 to PW4 will be maintained properly at least until a sample-and-hold operation and transfer operation are completed.

Next, an internal configuration of the semiconductor integrated circuit 1 will be described in detail. The semiconductor integrated circuit 1 contains a memory controller 110, a control CPU 120, a header addition controller 130, a data bit controller 140, a serial/parallel converter 150, a serial/parallel switching controller 160, an OR gate 170, the power controller 180 (described above), and interface circuits 101 to 105 corresponding to the ports P12, P11, P2 to P7 described above.

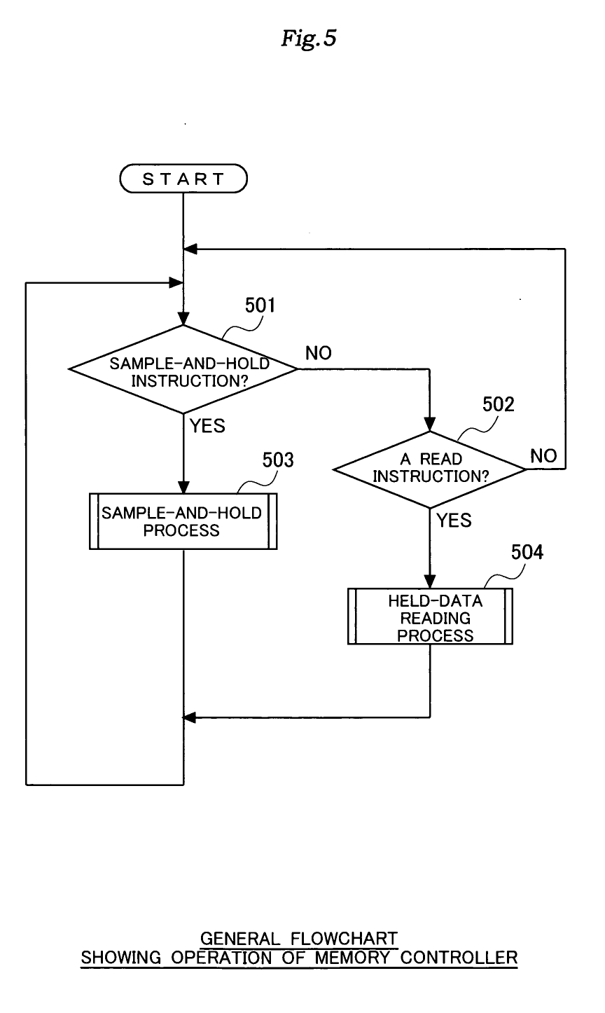

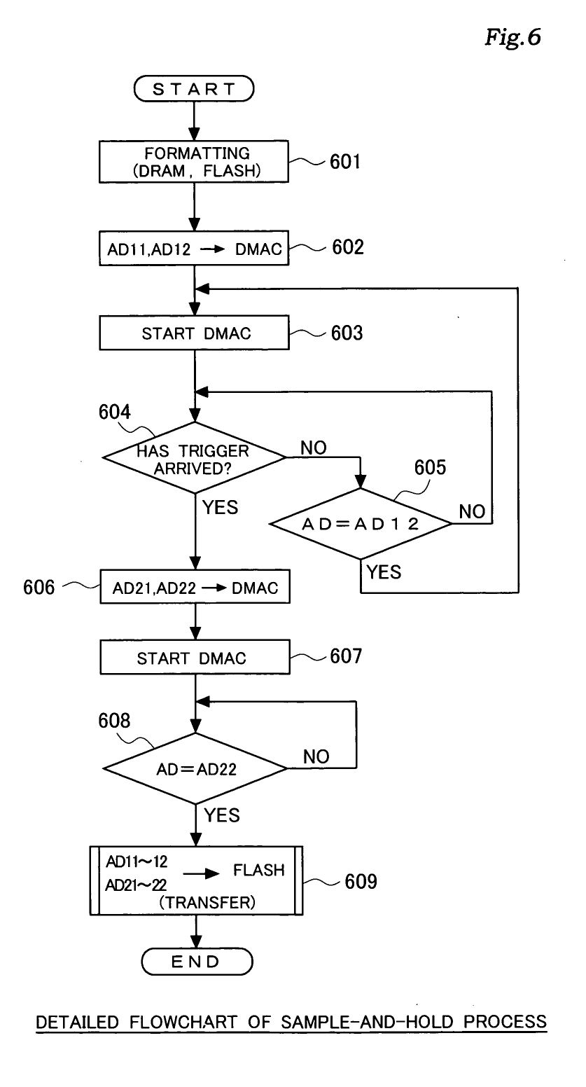

The memory controller 110 comprise of a clock-synchronized wired logic circuit which implements a control function for DMA transfer of the parallel input data P-DATA (IN) from the port P11 or the serial input data S-DATA (IN) from the port P12 to the first and second storage areas (described in detail later) of the DRAM 2, a control function for DMA transfer of the data stored in the first and second storage areas of the DRAM 2 to a predetermined area in the flash memory (FLASH) 3, a control function for reading the data stored in the predetermined area in the flash memory (FLASH) 3 to the outside via the port P5, and other functions. The memory controller 110 contains a DMA controller (DMAC) 110a and flash memory (FLASH) 10b. The DMA controller (DMAC) 110a is used for the data transfer functions described above. The flash memory (FLASH) 110b stores area definition data which defines the first and second storage areas of the DRAM 2, area definition data which defines storage areas in the flash memory (FLASH) 3, and other data. These storage area definition data are rewritable from external PCs via the control CPU 120 as described in detail later. Consequently, the semiconductor integrated circuit 1 is versatile enough to be compatible with any data string and sample-and-hold specification. The functions of the memory controller 110 will be described in detail later with reference to flowcharts in FIGS. 5 and 6.

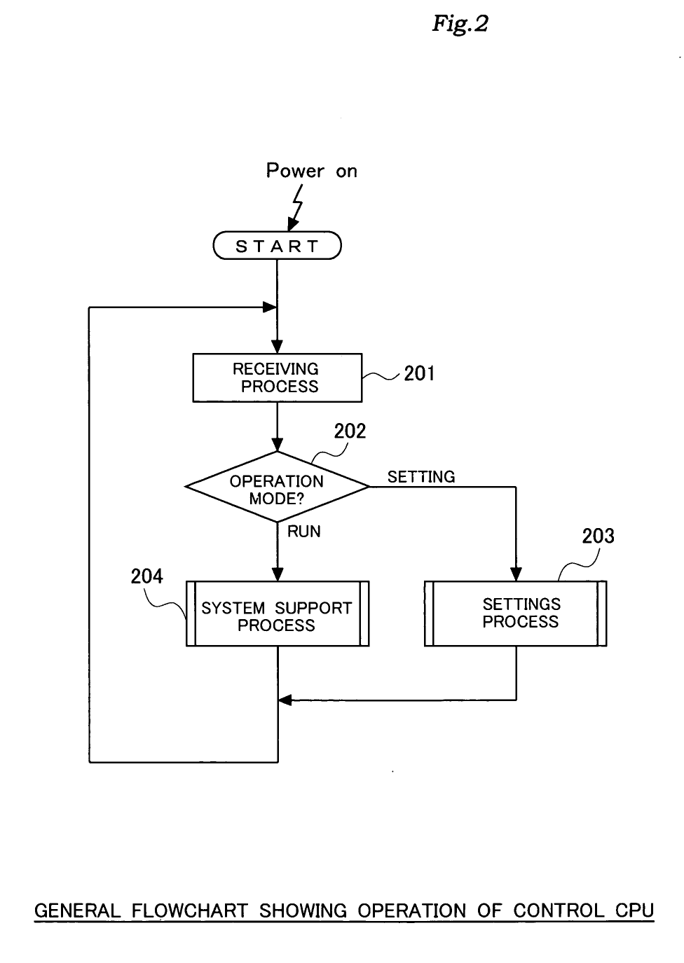

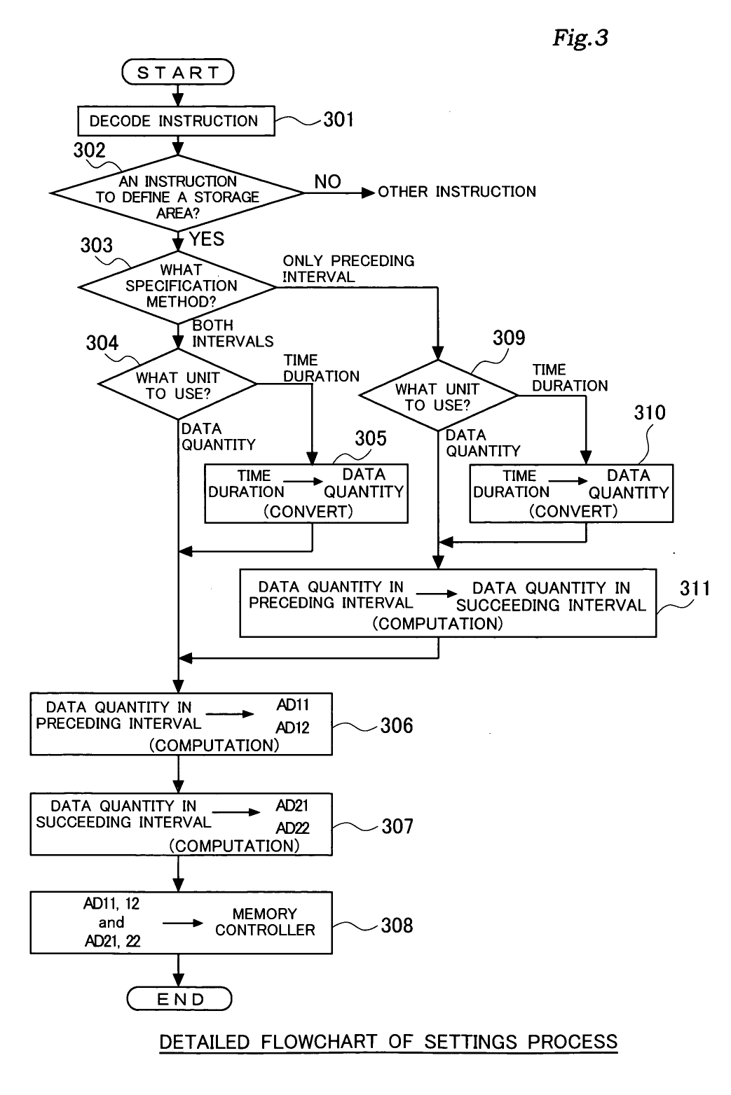

The control CPU 120 comprise mainly of a microprocessor. The control CPU 120 has (1) a function for performing various setting processes based on input data from the user while conducting communications with a PC connected to the port P6 via an USB interface 105, (2) a function for performing various system support processes and the like by centrally controlling the memory controller 110, header addition controller 130, and data bit controller 140. The control CPU 120 contains a flash memory (FLASH) 120a. The flash memory (FLASH) 120a stores various data loaded by the user via the PC. The functions of the control CPU 120 will be described in detail later with reference to flowcharts in FIGS. 2 and 3.

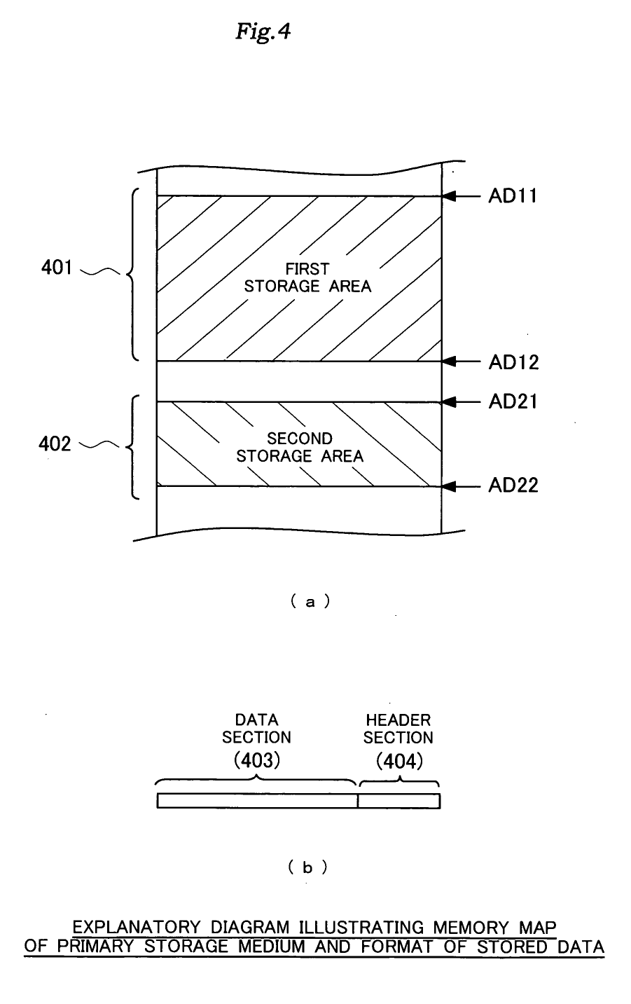

The header addition controller 130 comprise of a wired logic circuit which adds header information to the parallel input data P-DATA (IN) supplied via the port P11 and the serial input data S-DATA (IN) supplied via the port P12 (see FIG. 4(b)). In FIG. 4(b), reference numeral 403 denotes a data section and reference numeral 404 denotes a header section. The header information added here contains at least numeric information representing the order of incoming series of data. The numeric information is added cycling between predetermined minimum and maximum values. Later, sample-and-hold data is read and organized based on this numeric information which represents the data order.

The data bit controller 140 controls data bits with respect to the header addition controller 130, serial/parallel converter 150, parallel interface 101, and serial interface 102 under the control of the control CPU 120. The data bit control allows the header addition controller 130 to add header information to specified bits, allows the serial/parallel converter 150 to perform serial/parallel conversion of data bit strings properly, and allows the interfaces 101 and 102 to recognize input data bits properly.

The serial/parallel converter 150 is a circuit converting the serial input data S-DATA (IN) supplied to the port P12 and taken in through the serial interface 102 into parallel data. The resulting parallel data is supplied to the header addition controller 130 (described above) via the OR gate 170.

The serial/parallel switching controller 160 activates either the parallel interface 101 or serial interface 102 selectively under the control of the data bit controller 140. Proper functioning of the serial/parallel switching controller 160 allows the semiconductor integrated circuit 1 to handle both serial input data and parallel input data.

A clock controller 190 generates and outputs n types of control clock CLK1 to CLKn based on the operation clock CLK0 supplied from the clock oscillator 4 via the port P7, clock CLK(P) taken in through the parallel interface 101, and clock CLK(S) taken in through the serial interface 102. The control clocks CLK1 to CLKn thus obtained are supplied, as required, to various circuits in the semiconductor integrated circuit 1, contributing to normal operation of the clock-synchronized wired logic circuits. The clock controller 190 contains a phase-locked loop (PLL) circuit 190a, which synchronizes various clocks and helps synthesize frequencies.

Next, the functions of the control CPU 120 will be described in detail with reference to the flowcharts in FIGS. 2 and 3. As described above, the control CPU 120 is mainly designed to perform system support processes and settings processes.

A general flowchart showing operation of the control CPU is shown in FIG. 2. In the figure, as processing starts upon power-on, the control CPU 120 conducts communications with the PC connected to the port P6 via the USB interface 105. The control CPU 120 receives information from the PC and stores the information in the flash memory 120a (Step 201). This information includes control information on operation mode flags, thereby allowing the PC to switch the operation mode of the control CPU 120. Following the receiving process (Step 201), the control CPU 120 performs operation mode determining process (Step 202). If the operation mode is determined to be Setting mode, the control CPU 120 performs a settings process (Step 203). On the other hand if the operation mode is determined to be Run mode, the control CPU 120 performs a system support process (Step 204). In the settings process (Step 203), the control CPU 120 sets the arrival speed of the data to be sampled, data format, hold period before the trigger, and hold period after the trigger and performs other settings according to various sample-and-hold specifications. As described in detail later, the settings process (Step 203) includes area definition data generating process which defines the first and second storage areas. On the other hand, in the system support process (Step 204), the control CPU 120 controls the memory controller 110, header addition controller 130, and data bit controller 140, and thereby supports the system in the semiconductor integrated circuit 1, as described above.

A detailed flowchart of the settings process (Step 203) is shown in FIG. 3. This flowchart shows only the generating process of the storage area definition data out of the settings process (Step 203). In the figure, as processing starts, the control CPU 120 reads instruction command out of data received from the PC and decodes them (Step 301). Only when the decoded instruction is determined to be an instruction to define a storage area (Step 302: YES), the control CPU 120 performs the subsequent processes. Otherwise (Step 302: NO), the control CPU 120 performs other appropriate process according to the decoded instruction.

If the decoded instruction is determined to be an instruction to define a storage area (Step 302: YES), the control CPU 120 subsequently determines the type of the specification method to be used. According to this embodiment, when sampling and holding data strings which arrive during predetermined intervals before and after a triggering time, one of two specification methods can be selected: one of the methods involves specifying the preceding and succeeding intervals separately to define storage areas and the other method involves specifying only the preceding interval, leaving the succeeding interval to be defined automatically according to a predetermined algorithm. If it is determined that both intervals are specified (Step 303), the control CPU 120 subsequently determines the unit used to specify the data used (Step 304). In this example, two units are available to specify the length of the intervals before and after the trigger time: namely “time duration” and “data quantity.” If it is determined that “time duration” is used, the time duration is converted into data quantity (Step 305). On the other hand, if it is determined that “data quantity” is used, the unit is left as it is. Then, a first storage area is defined in the DRAM 2 based on the data quantity in the preceding interval (Step 306). The first storage area is defined by calculating the starting address AD11 and the ending address AD12 of the first storage area 401, as shown in FIG. 4(a). Then, a second storage area is defined in the DRAM 2 based on the data quantity in the succeeding interval. The second storage area is defined by calculating the starting address AD21 and the ending address AD22 of the second storage area 402 in the DRAM 2, as shown in FIG. 4(a). The storage area definition data (AD11, AD12, AD21, and AD22) obtained in the above processes (Steps 306 and 307) are transmitted to the memory controller 110 and stored in the flash memory 110b in the memory controller 110. Subsequently, the memory controller 110 perform data transfer process to the DRAM2 via the data input port P11 or P12, performs data transfer process from the DRAM2 to the flash memory (FLASH) 3, and performs data transfer process from the flash memory (FLASH) 3 to the output port P5 by referring to the storage area definition data (AD11, AD12, AD21, and AD22) stored in the flash memory 110b, as required.

Next, operation of the memory controller 110 will be described. A general flowchart showing the operation of the memory controller is shown in FIG. 5. In the figure, as processing starts, the memory controller 110 determines whether a sample-and-hold instruction has been given by the control CPU 120 (Step 501) or whether a read instruction has been given (Step 502). If a sample-and-hold instruction has been given (Step 501: YES), the memory controller 110 performs a sample-and-hold process (Step 503). On the other hand, if a read instruction has been given (Step 502: YES), the memory controller 110 performs a held-data reading process (Step 504). In the held-data reading process (Step 504), the held data H-DATA (OUT) stored in the flash memory 3 is transferred to the data output port P5.

A detailed flowchart of the sample-and-hold process is shown in FIG. 6. In the figure, as processing starts, a formatting process is performed first to format the DRAM2 and flash memory (FLASH) 3 (Step 601).

Then, after setting the starting address AD11 and ending address AD12 of the first storage area in the DMA controller (DMAC) 110a, the memory controller 110 starts up the DMA controller (DMAC) 110a (Step 603), thereby starting a DMA transfer of the data strings taken in from the header addition controller 130 to the first storage area 401 in the DRAM 2. If the parallel input port P11 has been selected by the serial/parallel switching controller 160, parallel input data P-DATA (IN) is transferred to the first storage area 401 in the DRAM 2. On the other hand, if the serial input port P12 has been selected, serial input data S-DATA (IN) is transferred to the first storage area 401 in the DRAM 2. Thus, the series of data strings arriving from the parallel input port P11 or serial input port P12 is written in sequence into the first storage area 401 shown in FIG. 4(a), beginning with the starting address AD11 to the ending address AD12. On the other hand, during the DMA transfer process, the memory controller 110 constantly checks for an arrival of a trigger signal TRG (Step 604) as well as a match between a transfer address AD and the ending address AD12 (Step 605). Each time a transfer address AD matches the ending address AD12 of the first storage area 401 (Step 605: YES), the DMA controller (DMAC) 110a is restarted (Step 603). Consequently, when the data writing process for writing into the first storage area 401 from the starting address AD11 to the ending address AD12 is completed, data is written into the first storage area 401 beginning with the starting address AD11 again, and thus overwriting process of the previous data is performed repeatedly. That is, the data strings which arrives via the data input port P11 or P12 are written into the first storage area 401 defined in the DRAM 2 on a so-called FIFO (First In First Out) basis with write addresses AD progressing in a wrap-around manner by the memory controller 110.

In this state, if a trigger signal TRG arrives at the port P2 and the arrival of the trigger is verified (Step 604: YES), the memory controller 110 sets the starting address AD21 and ending address AD22 of the second storage area 402 in the DMA controller (DMAC) 110a (Step 606), and then starts up the DMA controller (DMAC) 110a (Step 607), thereby starting a DMA transfer process to the second storage area 402. Consequently, the data strings supplied to the data input port P11 or P12 are transferred and stored in the second storage area 402 in the DRAM 2 via the header addition controller 130. Subsequently, when a destination address AD matches the ending address AD22 of the second storage area 402 (Step 608: YES), the transfer process to the second storage area 402 in the DRAM 2 is completed.

In this way, the series of data in a predetermined interval before the arrival of the trigger signal TRG is stored in the first storage area 401 and the series of data in a predetermined interval after the arrival of the trigger signal TRG is stored in the second storage area 402.

Then, the series of data extracted from the predetermined intervals before and after the arrival of the trigger and stored in the first storage area 401 and second storage area 402 in the DRAM 2 are transferred and saved in a predetermined area in the flash memory (FLASH) 3. Subsequently, even in incidences wherein power is shut down, the series of data in the flash memory (FLASH) 3 are retained securely.

Returning to FIG. 5, if a read instruction is given from a PC or the like (Step 502: YES), the memory controller 110 performs the held-data reading process (Step 504) to read the held data H-DATA (OUT) stored in a predetermined area in the flash memory 3 to the outside via the output port P5. In doing so, if the held data H-DATA (OUT) is read to the outside via the output port P5 after being sorted in the order of arrival based on the header information (header section 403) in the flash memory 3, this will save the trouble of sorting the held data later, and thus make it easy to handle the held data.

According to this embodiment, since the super capacitor 5 is connected between the external terminals T2 and T3, even if the power VDD supplied to the external terminal T1 is interrupted, the power in four systems PW1 to PW4 outputted from the power controller are maintained properly at least until the data writing operation into the second storage area 402 and data transfer from the DRAM 2 to the flash memory (FLASH) 3 are completed after the arrival of the trigger signal. Thus, for example, if the sample-and-hold apparatus is used as an in-car accident recorder or the like, when a trigger occurs as a result of an accident shutting down the power, it is possible to sample and hold various data at the time of the accident for predetermined periods of time before and after the accident, transfer and save the data in the flash memory 3, and use it to investigate the cause of the accident.

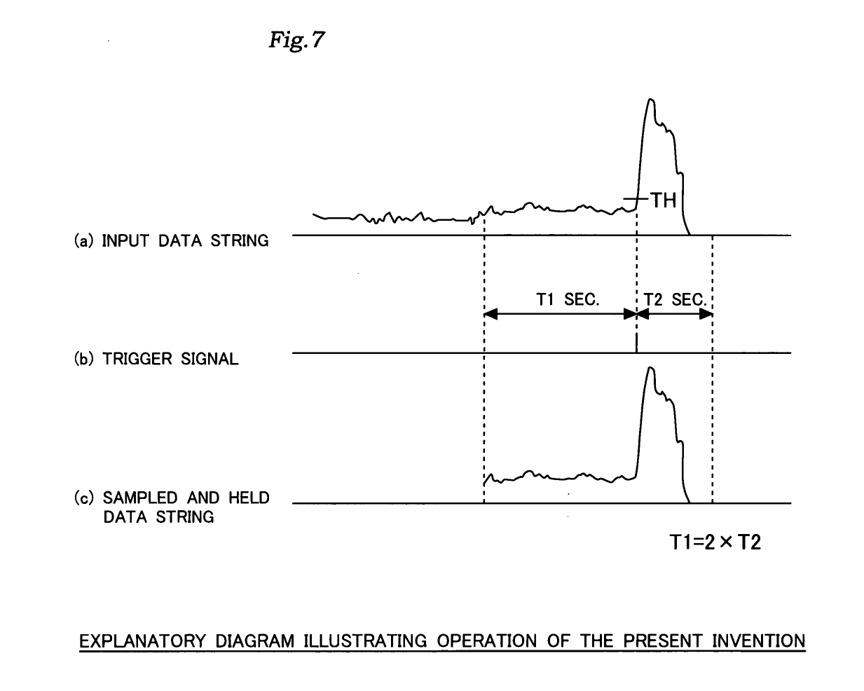

FIG. 7 is an explanatory diagram illustrating the operation of the present invention. Suppose arbitrary analog data are arriving in time sequence as shown in FIG. 7(a). If, for example, the value of input data exceeds a predetermined threshold value TH, generating a trigger signal as shown in FIG. 7(b), only the data strings which arrive during intervals within T1 seconds before or T2 seconds after the arrival of the trigger signal are sampled and held as shown in FIG. 7(c). In this example, the intervals have been set so as to satisfy the relationship T1=2×T2. Thus, when the sample-and-hold apparatus is used as an in-car accident recorder or the like, if the sample-and-hold apparatus is started up by a trigger signal generated by an airbag activation signal as soon as an accident occurs, series of data can be sampled and held for T1 seconds before and T2 seconds after the accident and saved in the flash memory (FLASH) 3. Consequently, if the apparatus is contained in a relatively rigid casing, the saved data read from the flash memory (FLASH) 3 after the accident will help investigate the cause of the accident.

In the above embodiment, the flash memory (FLASH) 3 is used as a secondary storage medium to make sure that sample-and-hold data is saved reliably, but it is not strictly necessary to provide a secondary storage medium if the stored data in the DRAM 2 can be retained for a week to a month, which can be achieved by increasing the capacity of the super capacitor 5. In that case, the transfer process (Step 609) from the DRAM 2 to the flash memory (FLASH) 3 can be omitted from the detailed flowchart of the sample-and-hold process shown in FIG. 6.

As described above, according to this embodiment, by simply connecting the data strings to be sampled to the port P11 or P12, trigger signals to the port P2, the DRAM 2 to the port P3, the flash memory (FLASH) 3 to the port P4, and the clock oscillator 4 to the port P7, it is possible, upon arrival of a trigger signal TRG, to sample and hold, only the series of data arriving during predetermined intervals before and after the arrival of the trigger signal TRG in the first storage area 401 and second storage area 402 of the DRAM 2, and save the content immediately in the flash memory (FLASH) 3. Then, if a read command is given from a PC, the sample-and-hold data stored in the flash memory (FLASH) 3 can be read out to the port P5 by the memory controller 110. Header information is included by the header addition controller 130 in each item of the data read out and the header information contains a numeric value which represents data order. Thus, the sample-and-hold data read out can be sorted easily in time sequence based on the numeric values.

The DRAM 2, flash memory (FLASH) 3, and clock oscillator 4 draw power from the power controller 180 in the semiconductor integrated circuit 1. At the same time, the power controller 180 is connected with the super capacitor 5 to maintain the power PW1 to PW4 for a predetermined period of time after a power failure. Thus, for example, when the sample-and-hold apparatus is used as an in-car accident recorder or the like, even in incidences wherein a trigger occurs as a result of an accident shutting down the power VDD, the DRAM 2, flash memory (FLASH) 3, and clock oscillator 4 can keep operating normally, which ensures that scheduled sample-and-hold operations are carried out in a reliable manner.

Moreover, the semiconductor integrated circuit 1 contains the control CPU 120 with a built-in microprocessor, allowing communications with a PC. This makes it possible for various settings such as switching between input ports (P11 and P12), setting a data bit count, configuring storage areas, and other settings easily from the PC, resulting in an extremely versatile semiconductor integrated circuit.

In particular, as shown in FIG. 3, this embodiment is provided with the port P6 which is inputted with control data and with the control CPU 120 which serves as area definition data generating means for internally generating area definition data based on the control data inputted through the port P6. This makes it possible to set up appropriate storage areas according to various sampling data by inputting appropriate control data to the port P6 from outside.

Specifically, by setting the control data from outside to contain both data indicating the capacity of the first storage area and data indicating the capacity of the second storage area, and by setting the area definition data generating means to generate area definition data based on the two sets of data (Step 303: “both intervals”), it is possible to set the first storage area and second storage area individually to any desired capacity by providing control data from outside. Alternatively, by setting the control data from outside to contain data indicating the capacity of the first storage area, but not data indicating the capacity of the second storage area, and by setting the area definition data generating means to generate area definition data based only on the data indicating the capacity of the first storage area (Step 303: “preceding interval”), it is possible to set the capacity of the first storage area and capacity of the second storage area properly by simply supplying control data which represents only the capacity of the first storage area, provided that an appropriate correlation between the capacity of the first storage area and capacity of the second storage area is defined in advance. Regarding the unit used to specify the intervals, since “time duration” and “data quantity” can be used selectively, the appropriate unit can be selected according to the kind of data to be analyzed.

Regarding the capacities of the first storage area 401 and second storage area 402 relative to each other in FIG. 4, preferably the storage capacity of the first storage area 401 is an integral multiple of the storage capacity of the second storage area 402 (more preferably the former is twice the latter). This will make it easy to collate the data stored in the first storage area and data stored in the second storage area in units of data strings when image data or voice data divided into frames are handled if the capacity of the second storage area is related to the size of the frame in advance.

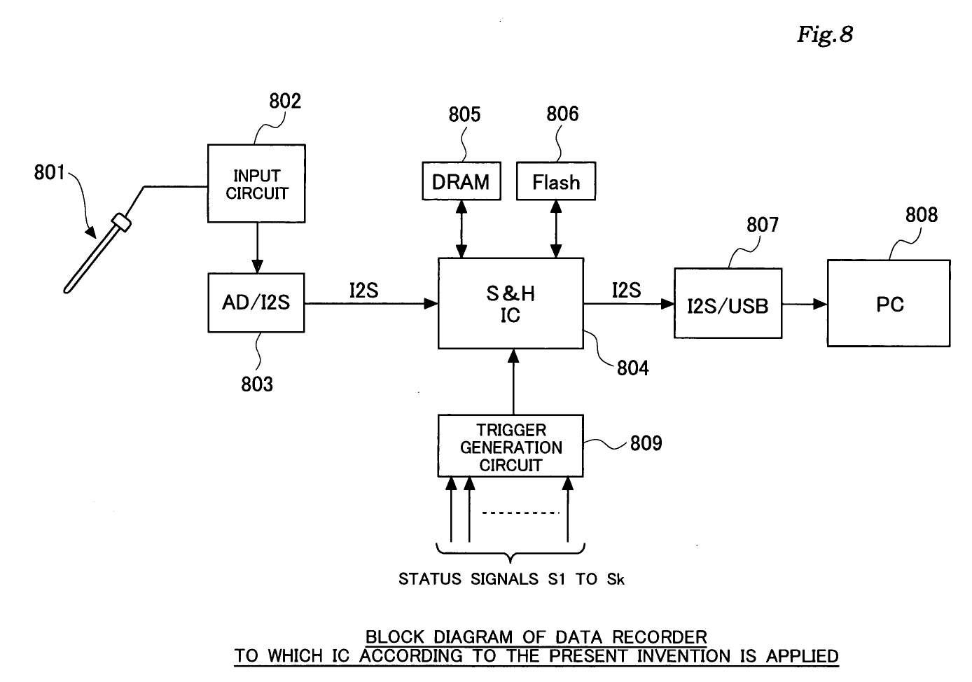

Finally, description will be given to some concrete application examples of a sample-and-hold IC according to the present invention. FIG. 8 shows a block diagram of a data recorder to which the sample-and-hold IC according to the present invention is applied. In the figure, reference numeral 801 denotes a probe which detects feature values of a measured object such as voltage, temperature, pressure, and flow rate; 802 denotes an input circuit which generates electrical signals corresponding to the feature values based on signals obtained from the probe; 803 denotes an AD/I2S conversion circuit which converts analog signals obtained from the input circuit into digital signals and transmits the digital signals to an I2S bus; 804 denotes the sample-and-hold IC according to the present invention; 805 denotes a DRAM which functions as a primary storage medium; 806 denotes a flash memory which similarly functions as a secondary storage medium; 807 denotes an I2S/USB conversion circuit which receives sample-and-hold data transmitted from the sample-and-hold IC 804 to the I2S bus and transmits the sample-and-hold data out to a USB bus; 808 denotes a personal computer which receives and processes the sample-and-hold data; and 809 denotes a trigger generation circuit which generates a trigger signal TRG when various status signals S1 to Sk (e.g., signals which represent temperature, pressure, sound volume, vibration, etc. around an object to be detected) satisfy predetermined conditions.

In this application example, the feature data detected by the probe 801 is constantly stored in a first storage area of the DRAM 805 using wrap-around addressing. When the status signals S1 to Sk satisfy the predetermined conditions, a trigger signal TRG is generated by the trigger generation circuit 809 and supplied to the sample-and-hold IC. Consequently, series of incoming feature data is written into a second storage area instead of the first storage area. Then, the data strings stored in the first and second storage areas are transferred to the flash memory 806 which is a secondary storage medium. Then, the data strings stored in the flash memory 806 (the data strings in predetermined intervals before and after the arrival time of the trigger signal) are read out and loaded onto the personal computer 808. If such a data recorder is installed in a car, by recording car speed, accelerator opening, engine conditions, brake conditions, and the like with an appropriate probe and generating a trigger signal using an airbag activation signal which is highly correlated with a car accident, it is possible to save valuable data at the time of an accident.

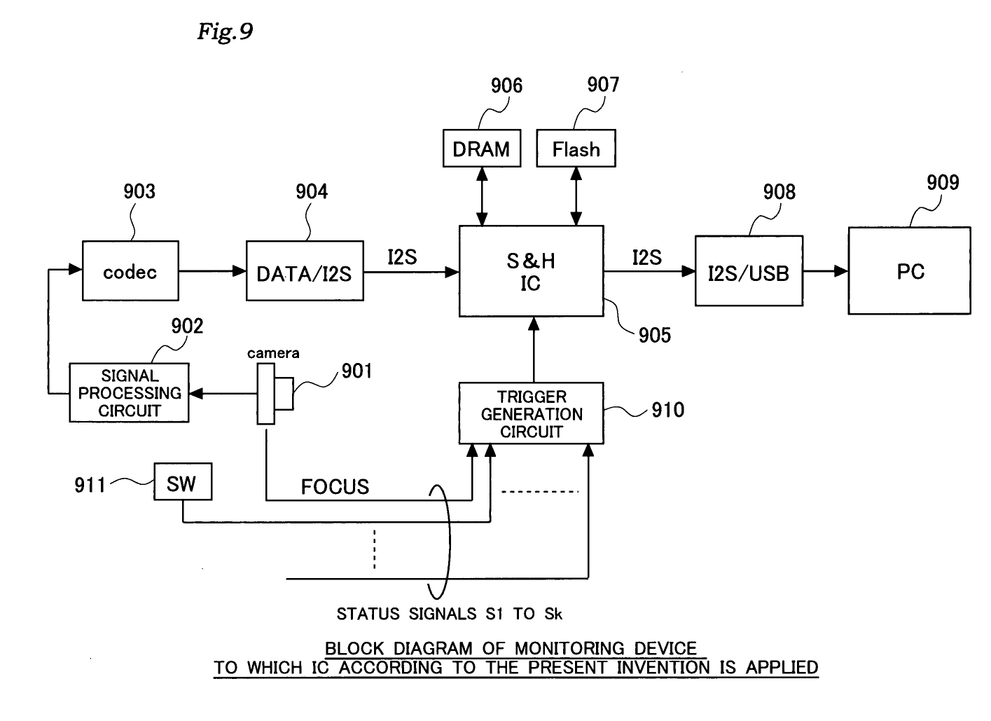

FIG. 9 shows a block diagram of a monitoring device to which the sample-and-hold IC according to the present invention is applied. In the figure, reference numeral 901 denotes a camera which includes a photographic lens and image sensor; 902 denotes a signal processing circuit which processes video signals from the camera; 903 denotes a compression/decompression circuit (codec) which compresses signals from the signal processing circuit; 904 denotes a DATA/I2S conversion circuit which transmits the data obtained from the compression/decompression circuit to an I2S bus; 905 denotes the sample-and-hold IC according to the present invention; 906 denotes a DRAM which functions as a primary storage medium; 907 denotes a flash memory which similarly functions as a secondary storage medium; 908 denotes an I2S/USB conversion circuit which receives sample-and-hold data transmitted from the sample-and-hold IC to the I2S bus and transmits the sample-and-hold data out to a USB bus; 909 denotes a personal computer which receives and processes the sample-and-hold data; and 910 denotes a trigger generation circuit which generates a trigger signal TRG when various status signals S1 to Sk (e.g., signals which represent temperature, pressure, sound volume, vibration, etc. around an object to be detected) satisfy predetermined conditions. In this example, status signals include a focus error signal obtained from the camera 901, a signal from a switch 911 placed in a monitoring area and activated by an intruder, a signal from an acceleration sensor (not shown) which is contained in the camera and detects the movement of the camera itself, a signal from a microphone (not shown) which gathers sounds in the monitoring area, and the video signals from the camera themselves.

In this application example, the image data acquired by the camera 901 is normally stored in a first storage area of the DRAM 906 using wrap-around addressing. If the status signals S1 to Sk satisfy the predetermined conditions caused by entry of an intruder in the monitoring area, a trigger signal TRG is generated by the trigger generation circuit 910 and supplied to the sample-and-hold IC 905. Consequently, series of incoming image data is written into a second storage area instead of the first storage area. Then, the image data strings stored in the first and second storage areas are transferred to the flash memory 907 which is a secondary storage medium. Then, the image data strings stored in the flash memory 907 (the image data strings in predetermined intervals before and after the arrival time of the trigger signal) are read out and loaded onto the personal computer 909. If such a monitoring device is applied to a security monitoring system at the door, when an intruder appears in front of the door, it is possible to save a series of images including the behavior of the intruder up to that time.

1. A data string sample-and-hold method for sampling and holding only series of data which is present during predetermined intervals before and after the arrival time of a predetermined trigger signal, out of a series of data which arrives successively, comprising:
a first step of preparing a primary storage medium in which a first storage area corresponding to the interval before the arrival time of the trigger signal and a second storage area corresponding to the interval after the arrival time of the trigger signal have been defined;
a second step of continuing to write a se4ries of incoming data into the first storage area using wrap-around addressing until the trigger signal arrives; and
a third step of writing a series of data arriving after the arrival of the trigger signal into the second storage area instead of ceasing to write data into the first storage area when the trigger signal arrives.

2. The data string sample-and-hold method according to claim 1, further comprising a fourth step of transferring the data written into the first and second storage areas of the primary storage medium to a secondary storage medium after the completion of the third step.

3. The data string sample-and-hold method according to claim 1, wherein the primary storage medium is a nonvolatile storage medium such as an optical memory suitable for high-speed storage or a volatile storage medium such as a DRAM equipped with back-up power.

4. The data string sample-and-hold method according to claim 2, wherein the primary storage medium is a volatile storage medium such as a DRAM suitable for high-speed storage and secondary storage medium is a nonvolatile storage medium such as a flash memory or hard disk.

5. The data string sample-and-hold method according to any of claims 1 to 4, wherein the storage capacity of the first storage area is an integral multiple of the storage capacity of the second storage area.

6. The data string sample-and-hold method according to claim 5, wherein the storage capacity of the first storage area is twice the storage capacity of the second storage area.

7. A data string sample-and-hold apparatus for sampling and holding only series of data which is present during predetermined intervals before and after the arrival time of a predetermined trigger signal, out of a series of data which arrives successively, comprising:
a primary storage medium;
an area definition data storage device for storing area definition data that defines a first storage area corresponding to the interval before the arrival time of the trigger signal and a second storage area corresponding to the interval after the arrival time of the trigger signal in the primary storage medium;
a first write control device for continuing to write a series of incoming data into the first storage area defined by the area definition data, using wrap-around addressing until the trigger signal arrives; and
a second write control device for writing a series of data arriving after the arrival of the trigger signal into the second storage area defined by the area definition data instead of ceasing to write data into the first storage area when the trigger signal arrives.

8. The data string sample-and-hold apparatus according to claim 7, further comprising:
a secondary storage medium; and
a data transfer control device for transferring the data written into the first and second storage areas of the primary storage medium to the secondary storage medium.

9. The data string sample-and-hold apparatus according to claim 7 wherein the primary storage medium is a nonvolatile storage medium such as an optical memory suitable for high-speed storage or a volatile storage medium such as a DRAM equipped with back-up power.

10. The data string sample-and-hold apparatus according to claim 8, wherein the primary storage medium is a volatile storage medium such as a DRAM suitable for high-speed storage and secondary storage medium is a nonvolatile storage medium such as a flash memory or hard disk.

11. The data string sample-and-hold apparatus according to any of claims 7 to 10, comprising a further area definition data generating device for internally generating area definition data based on input data from outside.

12. The data string sample-and-hold apparatus according to claim 11, wherein the input data from outside contains both data indicating the capacity of the first storage area and data indicating the capacity of the second storage area, and the area definition data generating device generates area definition data based on the two sets of data.

13. The data string sample-and-hold apparatus according to claim 11, wherein the input data from outside contains data indicating the capacity of the first storage area, but does not contain data indicating the capacity of the second storage area, and the area definition data generating device generates area definition data based only on the data indicating the capacity of the first storage area.

14. The data string sample-and-hold apparatus according to any of claims 7 to 10, wherein the storage capacity of the first storage area is an integral multiple of the storage capacity of the second storage area.

15. The data string sample-and-hold apparatus according to claim 14, wherein the storage capacity of the first storage area is twice the storage capacity of the second storage area.

16. A semiconductor integrated circuit comprising:
a first port which is inputted with series of data to be sampled;
a second port which is inputted with predetermined trigger signals' a third port connected to a predetermined storage medium;
a fourth port which outputs series of sampled and held data;
an area definition data storage device for storing area definition data which defines a first storage area and a second storage area in the storage medium connected to the third port;
a first write control device for continuing to write a series of data inputted through the first port into the first storage area of the storage medium connected to the third port, using wrap-around addressing until a trigger signal is input through the second port;
a second write control device for writing a series of data arriving after the arrival of the trigger signal into the second storage area of the storage medium instead of ceasing to write data into the first storage area of the storage medium when the trigger signal is inputted through the second port; and
a data read control device for performing control over transmission of data stored in the first storage area and the second storage area of the storage medium connected with the third port to the fourth port.

17. The semiconductor integrated circuit according to claim 16, wherein the storage medium is a nonvolatile storage medium such as an optical memory suitable for high-speed storage or a volatile storage medium such as a DRAM equipped with back-up power.

18. The semiconductor integrated circuit according to claim 16, comprising a power controller for supplying power not only in the semiconductor integrated circuit, but also to the storage medium connected externally, and to an oscillator connected externally and supplies an operation clock to the semiconductor integrated circuit.

19. The semiconductor integrated circuit according to claim 18, comprising an external terminal for connecting a super capacitor which maintains electric power supplied from the power controller for a predetermined time during a power failure.

20. The semiconductor integrated circuit according to any of claims 16 to 19, further comprising:
a fifth port which is inputted control data; and
a further area definition data generating device for internally generating the area definition data based on the control data inputted through the fifth port.

21. A semiconductor integrated circuit comprising:
a first port which is inputted with series of data to be sampled;
a second port which is inputted with predetermined trigger signals;
a third port connected to a predetermined primary storage medium;
a fourth port connected to a predetermined secondary storage medium;
a fifth port which reads sampled and held data;
an area definition data storage device for storing the area definition data which defines a first storage area and a second storage area in the primary storage medium connected to the third port;
a first write control device for continuing to write a series of data inputted through the first port into the first storage area of the primary storage medium connected to the third port, using wrap-around addressing until a trigger signal is input through the second port;
a second write control device for writing a series of data arriving after the arrival of the trigger signal into the second storage area of the primary storage medium instead of ceasing to write data into the first storage area of the primary storage medium when the trigger signal is inputted through the second port;
a data transfer control device for transferring the data written into the first and second storage areas of the primary storage medium connected with the third port to a secondary storage medium connected with the fourth port; and
a data read control device for performing control over transmission of data stored in the secondary storage medium connected with the fourth port to the fifth port.

22. The semiconductor integrated circuit according to claim 21, wherein the primary storage medium is a volatile storage medium such as a DRAM suitable for high-speed storage and secondary storage medium is a nonvolatile storage medium such as a flash memory or hard disk.

23. The semiconductor integrated circuit according to claim 21, comprising a power controller for supplying power not only in the semiconductor integrated circuit, but also to the primary and secondary storage media connected externally, and to an oscillator connected externally and supplies an operation clock to the semiconductor integrated circuit.

24. The semiconductor integrated circuit according to claim 23, comprising an external terminal for connecting a super capacitor which maintains electric power supplied from the power controller for a predetermined time during a power failure.

25. The semiconductor integrated circuit according to any of claims 21 to 24, wherein the storage capacity of the first storage area is an integral multiple of the storage capacity of the second storage area.

26. The semiconductor integrated circuit according to claim 25, wherein the storage capacity of the first storage area is twice the storage capacity of the second storage area.

27. The semiconductor integrated circuit according to any of claims 21 to 24, further comprising:
a sixth port which is inputted with control data; and
a further area definition data generating device for internally generating the area definition data based on the control data input through the sixth port.

28. The data string sample-and-hold apparatus according to claim 11, wherein the storage capacity of the first storage area is an integral multiple of the storage capacity of the second storage area.

29. The data string sample-and-hold apparatus according to claim 12, wherein the storage capacity of the first storage area is an integral multiple of the storage capacity of the second storage area.

30. The data string sample-and-hold apparatus according to claim 13, wherein the storage capacity of the first storage area is an integral multiple of the storage capacity of the second storage area.

31. The data string sample-and-hold apparatus according to claim 11, wherein the storage capacity of the first storage area is twice the storage capacity of the second storage area.

32. The data string sample-and-hold apparatus according to claim 12, wherein the storage capacity of the first storage area is twice the storage capacity of the second storage area.

33. The data string sample-and-hold apparatus according to claim 13, wherein the storage capacity of the first storage area is twice the storage capacity of the second storage area.

34. The semiconductor integrated circuit according to claim 25, further comprising:
a sixth port which is inputted with control data; and
a further area definition generating device for internally generating the area definition data based on the control data input through the sixth port.

35. The semiconductor integrated circuit according to claim 26, further comprising:
a sixth port which is inputted with control data; and
a further area definition generating device for internally generating the area definition data based on the control data input through the sixth port.
